(19) United States
(12) Patent Application Publication
(10) Pub. No.: US 2024/0027029 A1
(43) Pub. Date: Jan. 25, 2024

(54) INTEGRATED VAPOR PLUG TEMPERATURE MONITORING

(71) Applicant: Cryoport, Inc., Brentwood, TN (US)

(72) Inventors: Steven Wells, Huntington Beach, CA (US); Bret Bollinger, Yorba Linda, CA (US); Ben Lee, Corona, CA (US); Bobby Onel, Laguna Beach, CA (US)

(73) Assignee: Cryoport, Inc., Brentwood, TN (US)

(21) Appl. No.: 17/867,982

(22) Filed: Jul. 19, 2022

(51) Int. Cl. F17C 13/02; F17C 13/06

(52) U.S. Cl. CPC F17C 13/026; F17C 13/06; F17C 2205/0311; F17C 2270/0509; F17C 2250/046; F17C 2250/0439; F17C 2250/0631

(57) ABSTRACT

A system for recalibrating a temperature reading of a dewar includes a vapor plug and an electronic device. The vapor plug includes a vapor plug cover, a neck extending from the vapor plug cover, and a sensor positioned on the neck. The neck is configured to be inserted into an opening of the dewar. The sensor is configured to detect at least one parameter associated with the dewar. The electronic device is in communication with the sensor, and is configured to receive, recalibrate, and transmit the at least one parameter from the sensor.

### TECHNICAL FIELD

This specification relates to a system, device or apparatus for plugging or partially sealing a cryogenic device that stores and/or transports a liquid or gas under cryogenic temperatures.

### BACKGROUND

Lab technicians, scientists, medical professionals, such as doctors or nurses, and other technicians may cryogenically store and transport material to various facilities, such as hospitals, labs and research facilities. When transporting the material at a cryogenic temperature, the technicians and/or professionals store the material in a dry vapor shipper. The dry vapor shipper is a vacuum insulated container that is used to transport the material. The dry vapor shipper may be a dewar that has an inner vessel with a thin-walled neck tube and an outer vessel. The inner vessel may have an absorbent material. These dewars use the absorbent material to hold liquid nitrogen vapors to retain the extreme cold temperatures. The dewar has an internal chamber for loading product. In order to retain the cold temperatures, an apparatus, such as a vapor plug, is used to slow the escape of vapor gases. The vapor plug may act like a cork to partially seal an opening of the dewar. The vapor plug reduces the escape of vapors but does not create a seal. If the vapor plug were to seal the opening, this would create a dangerous pressurized vessel.

In the health, medical, pharmaceutical, and/or life science industries, safe storage and fast transportation of payload in a temperature-controlled environment is important. Thus, it is desirable that the dewar is a hardened reusable shipping container that maintains, regulates, or controls the payload area temperature in transporting temperature sensitive payload in such industries. As such, there is a need for systems and devices to provide an accurate temperature reading inside the payload area.

### SUMMARY

In general, one aspect of the subject matter described in this specification is a system for recalibrating a temperature reading of a dewar. The system includes a vapor plug and an electronic device. The vapor plug includes a vapor plug cover, a neck extending from the vapor plug cover, and a sensor positioned on the neck. The neck is configured to be inserted into an opening of the dewar. The sensor is configured to detect at least one parameter associated with the dewar. The electronic device is in communication with the sensor, and is configured to receive, recalibrate, and transmit the at least one parameter from the sensor.

In various embodiments, the recalibration correlates the sensor reading with an actual temperature of a payload area of the dewar. The payload area is configured to receive a payload and maintain a temperature of an environment surrounding the payload.

In various embodiments, the at least one parameter is at least one of humidity and temperature within the payload area.

In various embodiments, the sensor is a thermocouple.

In various embodiments, the electronic device is a data logger is configured to receive, store, and transmit data from the sensor.

In various embodiments, the vapor plug includes a channel disposed through a center of the vapor plug. The channel extends through the vapor plug cover and the neck.

In various embodiments, the channel includes a wire storage cavity. The channel is configured to receive a wire, the wire coupled to the sensor, and the wire storage is configured to receive excess of the wire.

In various embodiments, the wire secured in the channel is configured to electronically couple the electronic device and at least one of (i) a sensor controller connected to the sensor or (ii) the sensor.

In various embodiments, the system includes a display coupled to the electronic device, the display configured to receive the recalibrated parameter from the electronic device and display the recalibrated parameter.

In another aspect, a vapor plug system is described. The vapor plug system includes a vapor plug configured to at least partially seal a dewar, a sensor coupled to the vapor plug, and an electronic device comprising a processor operatively coupled to the sensor. The sensor is configured to detect a temperature within the dewar. The processor is configured to receive, from the sensor, a temperature reading of the dewar, recalibrate the temperature reading, and display the recalibrated temperature reading.

In various embodiments, the processor is configured to recalibrate the temperature reading based on a preprogrammed data set indicative of an expected temperature deviation.

In various embodiments, the system includes a memory configured to store the preprogrammed data set indicative of an expected temperature deviation.

In various embodiments, the electronic device is a data logger configured to receive, store, and transmit data from the sensor.

In various embodiments, the vapor plug comprises a vapor plug cover and a neck coupled to the vapor plug cover.

In various embodiments, the vapor plug comprises a channel disposed through a center of the vapor plug. The channel extends through the vapor plug cover and the neck.

In various embodiments, the channel includes a wire storage cavity. The channel is configured to receive a wire, the wire coupled to the sensor, and the wire storage is configured to receive excess of the wire.

In various embodiments, the wire secured in the channel is configured to electronically couple the electronic device and the sensor, wherein the electronic device is disposed in a cavity of the vapor plug.

In yet another aspect, a method of operating a vapor plug system is described. The method includes receiving a parameter of a dewar, recalibrating the parameter, and displaying the recalibrated parameter.

In various embodiments, recalibrating includes correlating the parameter with an actual parameter of a payload area of the dewar. The payload area is configured to receive a payload and maintain a temperature of an environment surrounding the payload.

In various embodiments, the parameter is at least one of humidity and temperature within the payload area.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1A illustrates a top view of a vapor plug according to various embodiments;

FIG. 1B illustrates a cross-sectional side perspective view of the vapor plug of FIG. 1A according to various exemplary embodiments;

FIGS. 1C-1D illustrate an exploded view of the vapor plug of FIG. 1A according to various exemplary embodiments;

FIG. 1E is a perspective view of the vapor plug of FIG. 1A according to various exemplary embodiments;

FIG. 2 illustrates a block diagram of a vapor plug system according to various exemplary embodiments;

FIG. 3 illustrates a vapor plug inserted in a dewar according to various exemplary embodiments; and

FIG. 4 illustrates a method for providing an accurate temperature reading of a dewar payload according to various exemplary embodiments.

### DETAILED DESCRIPTION

Disclosed herein are systems, devices and/or methods for plugging or partially sealing a cryogenic device, such as a dewar, that stores and/or transports a liquid or gas under cryogenic temperatures. A vapor plug partially seals an inner vessel of the dewar. The dewar may be a double-walled vacuum insulated container that is used to transport commodities at cold temperatures, such as cryogenic temperatures. The dewar may have an inner wall that is lined with an absorbent material and an outer wall, which forms an inner vessel and an outer vessel. The inner vessel of the dewar may have a neck portion. The neck portion may have an opening that receives the material and stores the material in the inner vessel. The absorbent material may be a liquid or gas.

The vapor plug may act like a cork to partially seal the opening and reduce the amount of liquid or gas that evaporates, while also equalizing the pressure within the dewar so that pressure does not build up within the dewar. By reducing the amount of liquid or gas that evaporates, the vapor plug also minimizes the amount of warm air that is pulled in to replace the evaporated liquid or gas, which prolongs the amount of time that the dewar can maintain the cryogenic temperatures.

A desirable temperature reading is approximately −196 degrees Celsius, however an artificially high reading occurs when a thermocouple is located on the vapor plug. For instance, the deviation in the temperature may provide a reading around −140° C. to −155° C. instead. The erratic temperature readings may be due to the vapor plug being loose fitting so air can be pulled in or pushed out. Conversely, when a probe, or thermocouple, is located further into the payload area, installation and uninstallation problems may arise. For instance, cold temperatures during installation and uninstallation may damage the probe, which can lead to excess cost and/or time due to the considerable amount of time needed to wait for the dewar to warm up (e.g., 24 hrs, 48 hrs) to prevent or mitigate damage to probe.

Accordingly, as described herein, the probe may be positioned on the vapor plug of a vapor plug system which includes a logic (such as a controller or control algorithm) configured to consider the payload area temperature (e.g., toward the middle of the payload area) and the vapor plug temperature and determine a correlation to convert the temperature taken near the vapor plug to the payload area temperature. As such, the vapor plug system reduces the need to replace the probe.

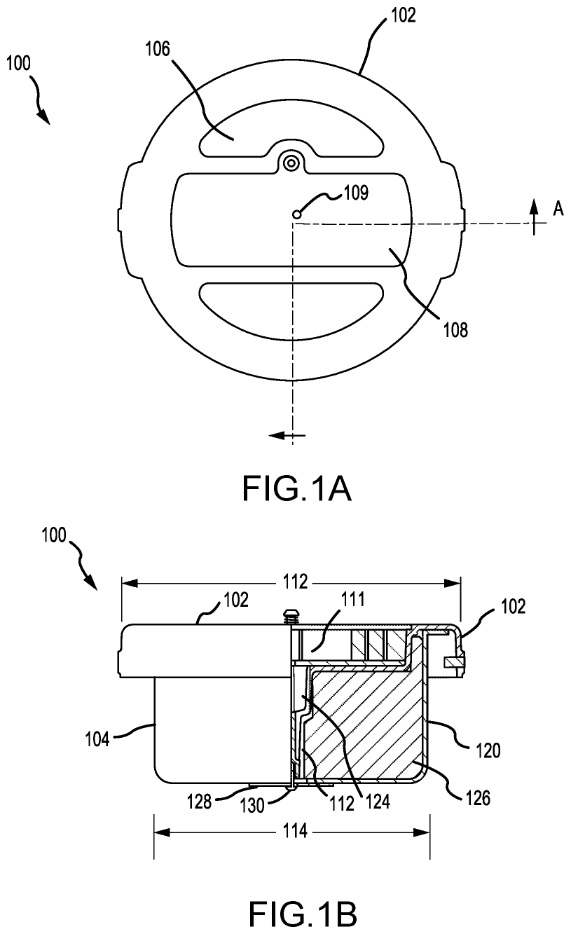

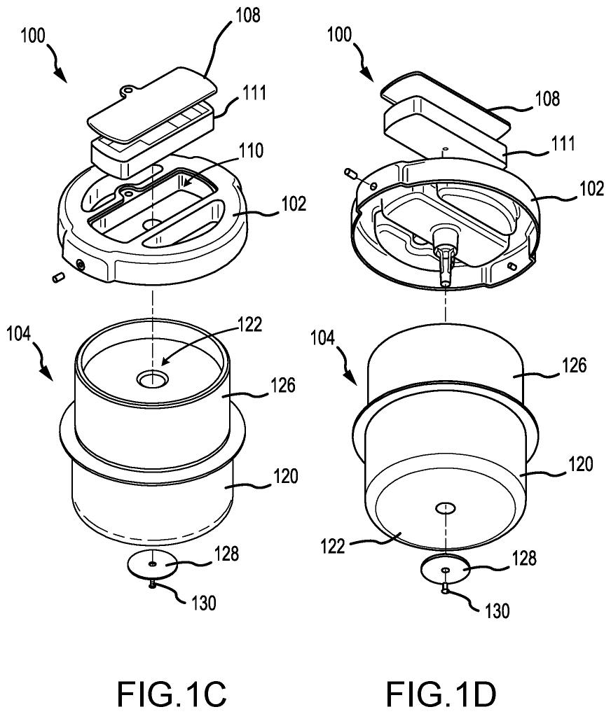

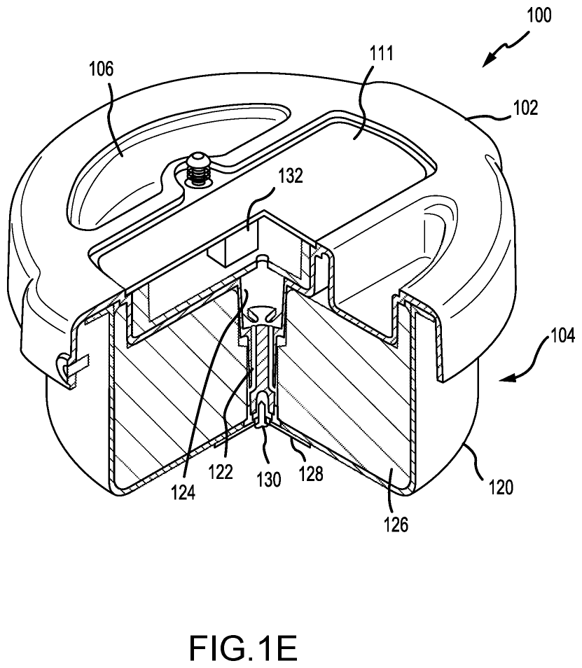

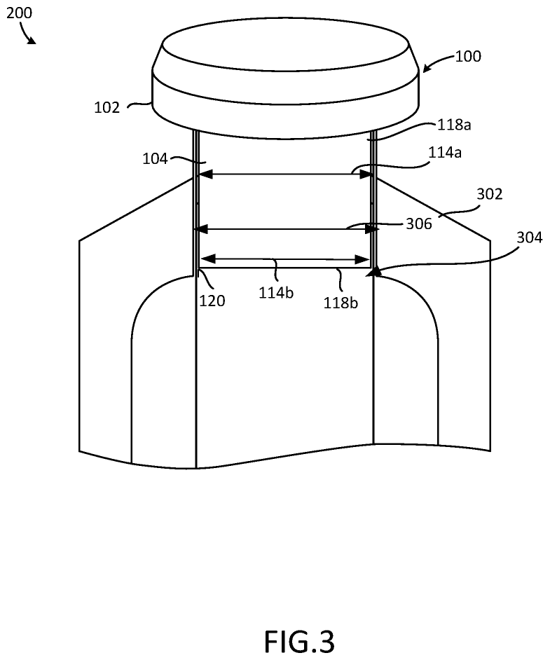

FIGS. 1A-1E show a vapor plug 100 in an exemplary embodiment. FIG. 1A shows an exterior view of the vapor plug 100. FIG. 1B shows a cross-sectional side perspective view of the vapor plug 100. The vapor plug 100 reduces evaporation of a liquid or gas in a dewar 302 when the vapor plug 100 is inserted into an opening of the dewar 302, as shown in FIG. 3 for example. The vapor plug 100 may partially seal the dewar 302. That is, the vapor plug 100 allows the liquid or gas to escape the dewar 302 to equalize the pressure within the dewar 302, but may also, obstruct and/or reduce the amount of liquid or gas that escapes to limit evaporation and limit warm air from entering into the dewar 302. This maintains the cryogenic temperatures within the dewar 302 to allow for continued cryogenic storage of the material stored within the dewar 302.

In various embodiments, the vapor plug 100 is removable. Specifically, the vapor plug 100 may be inserted into an opening of the dewar 302 to partially seal and/or limit access to a cavity 304 of the dewar 302. The vapor plug 100 may be removed from the cavity 304 of the dewar 302 to allow liquid and/or gas to escape from the cavity 304 of the dewar 302.

The vapor plug 100 has a vapor plug cover 102 and a neck 104. The vapor plug cover 102 has a handle 106 and a door 108. The vapor plug 100 may be made from a single component, such as a unitary interconnected or integral piece, or multiple components that are interconnected, such as using one or more fasteners.

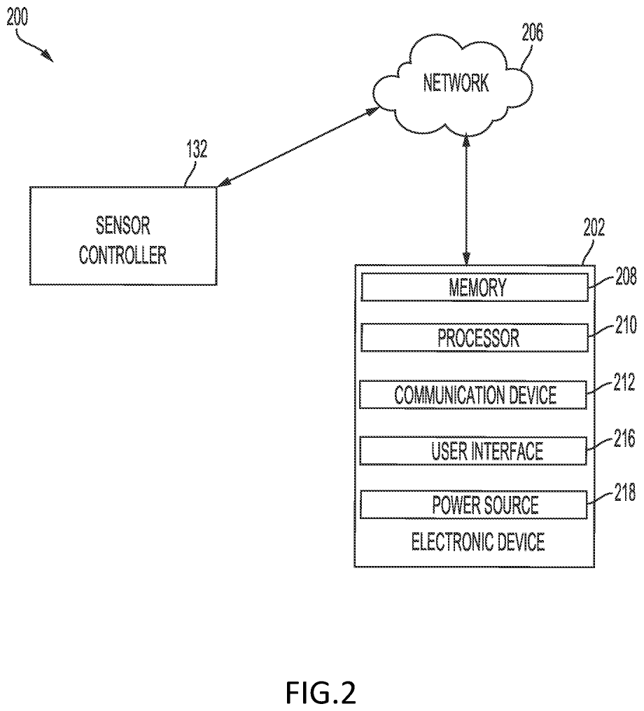

The vapor plug cover 102 may be a lid and/or may be cylindrically or circularly shaped. The vapor plug cover 102 may have a recess 110 that is positioned within the center of the vapor plug cover 102. The recess 110 may be configured to receive a foam padding 111 to support and stabilize other articles, such as an electronic device 202 (FIG. 2).

The vapor plug cover 102 may have a circumference and a cover diameter 112 that is greater than the circumference and neck diameter 114 of the neck 104. The circumference and the cover diameter 112 may be greater than the circumference and dewar opening diameter 306 (FIG. 3) of the opening of the dewar 302 (FIG. 3) so that the vapor plug cover 102 covers the opening of the dewar 302 (FIG. 3).

The vapor plug cover 102 may have or be coupled to a handle 106. The handle 106 allows for ease of access to remove or insert the vapor plug 100 into the opening of the dewar 302 to partially seal the cavity 304 of the dewar 302, as shown in FIG. 3 for example. The handle 106 may be shaped to allow for a user to easily grasp the handle 106 so that the user may lift or otherwise remove the vapor plug 100 from the opening of the dewar 302. The handle 106 may be a recess with a shape such as a crescent, a semi-circle, a square, rectangular, hexagonal, etc.

The vapor plug 100 includes a neck 104. The neck 104 may be cylindrically-shaped and inserted into the opening of the dewar 302 (FIG. 3). The neck may be made from a polystyrene material, a combination of materials, or any material as desired. The neck 104 may have a first end 118a and a second end 118b that is opposite the first end 118a. The first end 118a may be coupled to the vapor plug cover 102 and proximal to the opening of the dewar 302 (FIG. 3). The second end 118b may be inserted into the cavity 304 (FIG. 3) of the dewar 302 (FIG. 3) via the opening of the dewar 302 (FIG. 3). The second end 118b may reside within the neck of the dewar 302 (FIG. 3) when inserted into the opening of the dewar 302 (FIG. 3).

In various embodiments, the first end 118a and the second end 118b may have different diameters. The first end 118a may have a first neck diameter 114a and/or a circumference that is greater than the second neck diameter 114b and/or the circumference of the second end 118b. For example, the vapor plug 100 may be a tapered vapor plug that has a neck with a tapered second end 118b that is inserted into the opening of the dewar 302 (FIG. 2). The second end 118b may be angled and gradually tapered inward toward the center of the neck 104 from the first end 118a to form an inverted frustoconical shape. The taper may begin at a point where loss due to thermal insulation is equivalent to the straight wall design and the surface temperature of the vapor plug 100 is warmer than the freezing point of water. This results in the second end 118b having the second neck diameter 114b and/or the circumference that is less than the first neck diameter 114a and/or the circumference of the first end 118a. Moreover, the diameter of the neck gradually decreases from the first end 118a to the second end 118b as the neck tapers or angles inward to form the inverted frustoconical shape.

Referring still to FIGS. 1A-B, the vapor plug 100 may have a liner 120. The liner 120 may be fleece, sleeve or sock that has an opening on a proximal end that is shaped to receive the neck 104 of the vapor plug 100 and closed on the other end that is inserted into the opening of the dewar 302. The liner 120 may be a hydrophobic liner that repels water vapor, such as condensation or other moisture that may build up on the liner 120. As such, when the neck 104 is inserted into the liner 120 and the liner 120 is snugly fit around the neck 104, the liner 120 protects the neck 104 from the buildup of condensation and/or moisture on the neck 104. Additionally, the liner 120 ameliorates the escape of cryogen within the payload area of the dewar 302 from the dewar 302.

The vapor plug 100 further includes a channel 122 disposed through the center of the vapor plug 100. The channel 122 may be configured to receive a wire (e.g., a thermocouple). The channel 122 may extend from a top of the vapor plug cover 102 to a bottom of the neck 104 (e.g., a side of the vapor plug opposite from the top of the vapor plug cover 102, the second end 118b). Particularly, the channel 122 extends through the door 108 and the foam padding 111. As such, the door 108 may include an access point 109 wherein a wire disposed in the channel 122 may be accessed. The channel 122 includes a wire storage cavity 124. The wire storage cavity 124 may have a circumference larger than the channel 122. In various embodiments, the wire storage cavity 124 may be disposed adjacent to the channel 122 within the neck 104. The wire storage cavity 124 may be configured to receive excess wire when a wire is disposed in the channel 122. In various embodiments, the channel 122 and the wire storage cavity 124 may be surrounded by an insulation material 126. For instance, the neck 104 is composed of the insulation material 126. In various embodiments, the insulation material 126 may be configured as a layer where the layer may be disposed in confronting relation with the channel 122 and/or the perimeter of the neck 104.

The vapor plug 100 may further include a disk 128. The disk 128 may be configured to function as a dampener. For instance, the disk 128 may prevent, or reduce, warm air, gas, vapor, or fluid, or radiant energy to alter a temperature reading. The disk 128 may be disposed on the bottom of the neck 104 at the second end 118b. The disk 128 may be a washer, for instance, such that the disk 128 has a center through-hole. The disk 128, and particularly the center through-hole, may align with the channel 122. As such, the wire disposed in the vapor plug 100 may be threaded through the disk 128.

The vapor plug 100 includes a thermocouple connector 130. The thermocouple connector 130 may be configured to transmit a temperature reading to an instrument via a wire (e.g., the wire fed through the channel 122), the instrument configured to receive and measure the temperature reading. For instance, the thermocouple connector 130 may be coupled to a sensor, which may be positioned, embedded or included within, or connected to the neck 104 of the vapor plug 100. The sensor may be an electronic device or sensor that measures and monitors the temperature within the dewar 302. For instance, the sensor may be a thermocouple, a dampening probe, or the like, etc. extending from the thermocouple connector 130 and into the payload area of the dewar 302 to measure the temperature of the payload area. The sensor (e.g., an electronic thermocouple) may wirelessly transmit and/or communicate with another electronic device, such as a smart data logger, using a wireless protocol. For instance, the vapor plug 100 may include a sensor controller 132 (e.g., a thermocouple controller) configured to control the sensor. The wire secured in the channel 122 is configured to electronically couple the electronic device and at least one of the sensor, or the sensor controller 132 connected to the sensor. Accordingly, the sensor may communicate, via the sensor controller 132, and provide the temperature to the smart data logger and/or may receive instructions from the smart data logger to monitor the temperature. The smart data logger may display or otherwise communicate the temperature to a user or another electronic platform. This allows for real-time monitoring of the temperature within the dewar 302 by other individuals.

Referring now to FIG. 2, a block diagram of a vapor plug system 200 is illustrated. The vapor plug system 200 includes the vapor plug 100 and an electronic device 202, which may be a smart data logger. The vapor plug 100 and the electronic device 202 may be connected via the network 206. Moreover, the vapor plug 100 and/or the electronic device 202 may be directly interconnected in addition to or in lieu of connection via the network 206. The network 206 may be a local area network (LAN), a wide area network (WAN), a cellular network, the Internet, or combination thereof, that connects, couples and/or otherwise communicates between the different components of the vapor plug system 200. The network 206 may be a direct connection via a wire.

The electronic device 202 may be a smart data logger. The electronic device 202 may be contained within a shipping container wherein the vapor plug is located and stay within proximity to the vapor plug 100 such that the electronic device 202 stays in communication with the vapor plug 100. In various embodiments, the electronic device 202 and the vapor plug 100 are co-located in a shared housing and may share electronic components. The electronic device 202 may be directly connected to the vapor plug 100 such as via a wired or wireless connection. In further instances, the electronic device 202 is not directly connected to the vapor plug 100 but is instead connected to the vapor plug 100 via the network 206.

The electronic device 202 may include a memory 208, one or more processors 210, and/or a communication device 212. The electronic device 202 may include a user interface 216 and/or a power source 218. The memory 208 may store data indicative of an expected temperature discrepancy between a temperature reading at the vapor plug 100 and a temperature reading at the payload area. The memory 208 may store instructions executed by the one or more processors 210. The memory 208 may include one or more of a Random Access Memory (RAM) or other volatile or non-volatile memory. The memory 208 may be a non-transitory memory or a data storage device, such as a hard disk drive, a solid-state disk drive, a hybrid disk drive, or other appropriate data storage, and may further store machine-readable instructions, which may be loaded and executed by the one or more processors 210.

The user interface 216 may include an input device that receives user input from a user interface element, a scanner, button, a dial, a microphone, or a keyboard but may not have an output device, such as a display, a speaker, an audio and/or visual indicator, a touch-screen display or a refreshable braille display. The power source 218 may be used to power the electronic device 202.

In some embodiments, the user interface 216 may be provided by the electronic device 202. For example, the user interface 216 may be presented on a touch-screen display of the electronic device 202. The power source 218 may be used to power the electronic device 202 as well as the user interface 216. In some embodiments, the user interface 216 and the electronic device 202 may be powered individually by separate power sources.

The one or more processors 210 may be coupled to the memory 208, the communication device 212, the user interface 216, and/or the power source 218. The one or more processors 210 may perform functions, such as obtaining the temperature reading from the vapor plug 100 and providing the temperature reading to the user interface 216.

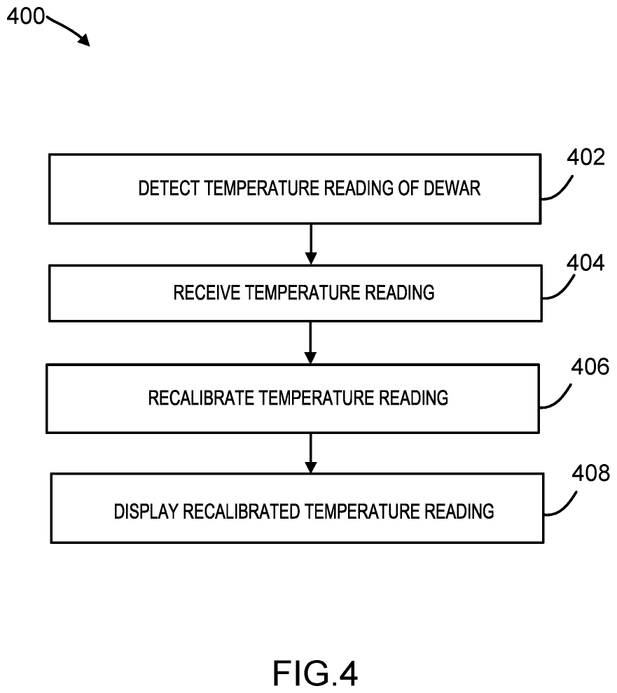

Referring now to FIG. 4, a method 400 of providing an accurate temperature reading of a dewar payload is illustrated. At 402, a sensor (e.g., a probe, a thermocouple, etc.) located on a plug of the dewar detects a temperature reading of the dewar. At 404, an electronic device receives the temperature reading from the sensor. At 406, the electronic device recalibrates the temperature reading to correlate with an actual payload area temperature. A memory of the electronic device may store predetermined data sets indicative of artificially high readings which occur when a thermocouple is located on the vapor plug due to the vapor plug being loose fitting so air can be pulled in or pushed out. For instance, the deviation in the temperature may provide a reading around −140° C. to -155° C. instead of −196° C. The data sets may be referenced to calculate a measurement deviation (e.g., of approximately 40-50 degrees, and recalibrate the temperature reading to reflect the inaccuracy. Accordingly, at 408, the electronic device displays the convert temperature measurement.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for recalibrating a temperature reading of a dewar, comprising:
a vapor plug, comprising:
a vapor plug cover;
a neck extending from the vapor plug cover, the neck configured to be inserted into an opening of the dewar; and
a sensor positioned on the neck, the sensor configured to detect at least one parameter associated with the dewar; and
an electronic device in communication with the sensor, the electronic device configured to receive, recalibrate, and transmit the at least one parameter from the sensor.

2. The system of claim 1, wherein the recalibration correlates the sensor reading with an actual temperature of a payload area of the dewar, the payload area configured to receive a payload and maintain a temperature of an environment surrounding the payload.

3. The system of claim 1, wherein the at least one parameter being at least one of humidity and temperature within a payload area of the dewar.

4. The system of claim 1, wherein the sensor is a thermocouple. The system of claim 1, wherein the electronic device is a data logger configured to receive, store, and transmit data from the sensor.

6. The system of claim 1, wherein the vapor plug comprises a channel disposed through a center of the vapor plug, the channel extending through the vapor plug cover and the neck.

7. The system of claim 6, wherein the channel comprises a wire storage cavity, wherein the channel is configured to receive a wire, the wire coupled to the sensor, and the wire storage cavity is configured to receive excess of the wire.

8. The system of claim 7, wherein the wire secured in the channel is configured to electronically couple the electronic device and at least one of (i) a sensor controller connected to the sensor or (ii) the sensor.

9. The system of claim 1, further comprising a display coupled to the electronic device, the display configured to receive the recalibrated parameter from the electronic device and to display the recalibrated parameter.

10. A vapor plug system, comprising:
a vapor plug configured to at least partially seal a dewar;
a sensor coupled to the vapor plug; the sensor configured to detect a temperature within the dewar;
an electronic device comprising a processor operatively coupled to the sensor, the processor configured to:
receive, from the sensor, a temperature reading of the dewar;
recalibrate the temperature reading; and
display the recalibrated temperature reading.

11. The vapor plug system of claim 10, wherein the processor is configured to recalibrate the temperature reading based on a preprogrammed data set indicative of an expected temperature deviation.

12. The vapor plug system of claim 11, further comprising:
a memory configured to store the preprogrammed data set indicative of the expected temperature deviation.

13. The vapor plug system of claim 10, wherein the electronic device is a data logger configured to receive, store, and transmit data from the sensor.

14. The vapor plug system of claim 10, wherein the vapor plug comprises a vapor plug cover and a neck coupled to the vapor plug cover.

15. The vapor plug system of claim 14, wherein the vapor plug comprises a channel disposed through a center of the vapor plug, the channel extending through the vapor plug cover and the neck.

16. The vapor plug system of claim 15, wherein the channel comprises a wire storage cavity, wherein the channel is configured to receive a wire, the wire coupled to the sensor, and the wire storage cavity is configured to receive excess of the wire.

17. The vapor plug system of claim 16, wherein the wire secured in the channel is configured to electronically couple the electronic device and the sensor, wherein the electronic device is disposed in a cavity of the vapor plug.

18. A method of operating a vapor plug system, the method comprising:
receiving a parameter of a dewar;
recalibrating the parameter; and
displaying the recalibrated parameter.

19. The method of claim 18, wherein recalibrating includes correlating the parameter with an actual parameter of a payload area of the dewar, the payload area configured to receive a payload and maintain a temperature of an environment surrounding the payload.

20. The method of claim 18, wherein the parameter is at least one of humidity and temperature within a payload area of the dewar.
